(19) United States
(12) Patent Application Publication
(10) Pub. No.: US 2010/0070334 A1
(43) Pub. Date: Mar. 18, 2010

(54) METHOD AND SYSTEM FOR LOCATION-BASED MOBILE DEVICE PREDICTIVE SERVICES

(76) Inventor: Dante Monteverde, Barrington Hills, IL (US)

Correspondence Address: SEYFARTH SHAW LLP, 131 S. DEARBORN ST., SUITE 2400, CHICAGO, IL, 60603-5803, US

(21) Appl. No.: 12/206,553

(22) Filed: Sep. 8, 2008

(51) Int. Cl. G06Q 30/00; G06F 7/06; G06F 17/30

(52) U.S. Cl. 705/10; 707/E17.014; 705/14.64; 705/14.58

(57) ABSTRACT

Systems and methods for providing predictive services and/or goods to a mobile device user are disclosed. A mobile device is able to obtain location information which is then processed to determine a present location of a user, and a nature of that location may be associated therewith, either by user input or by accessing a database having stored natures for that location. The location and nature may be stored as a record, and/or may be compared to stored records of stored locations and correlated natures. The predictive service makes a determination of possible future locations and natures of the user, different from the present location and nature thereof, to provide offerings to the mobile device.

### FIELD OF THE INVENTION

The present application relates to methods and systems for predictive goods and/or services and, in particular, to methods and systems for predicting a user's needed or desired goods and/or services with a hand-held device based on the location of the hand-held device.

### BACKGROUND

Currently, users of a variety of devices are able to utilize a many different predictive technologies. As a simple and basic example, it is well-known for users of email to begin typing an e-mail address, whereupon the address bar makes a prediction of the intended e-mail recipient by autopopulating the e-mail address field with known e-mail addresses (based upon, for example, the user's prior e-mail recipient history or contacts listing) and giving the user the option of accepting one of the predicted e-mail addresses. What should be noted about this type of predictive service is that the offered e-mail address is typically based on historically input e-mail addresses, and the e-mail application has no ability to predict e-mail address which has never been used or is not otherwise located in the user's contacts list.

These predictive technologies seek to provide predictive offerings based on an initial entry or search query provided by the user. For example, from an input query, the predictive technologies attempt to categorize the search results by predicting information, goods or services that the searching user may be interested. Predictive technologies for search technologies are disclosed by U.S. Pat. No. 7,512,059, to Monteverde, and by U.S. Pat. No. 6,876,997, to Rorex, et al. As an example of predictive search technology, a user may input a search query regarding “cars,” and the user may receive a set of search results including documents including the word “cars,” a category or list of results for researching the purchase of cars, a category describing components of cars, and/or a category of listings for car dealerships. Such described set of search results are generally based on significance so that, in response to a particular query, the search results presented are, at least in part, based on search results that other people selected when submitting similar queries. Other results my include car related services, such as oil change services, wherein the system is attempting to “predict” what the user's needs may be.

Some Internet search technologies allow time-based evolution of predictive search so that a particular query is considered for relevance to current events; as an example, a search query for the term “election” may result in documents reporting current events related to a recent major election.

Internet search results may be tailored to a specific location provided by a user. Some search engines, providing a so-called ‘yellow pages’ function, may categorize the results based on a location chosen by the Internet user, such as providing a city and state or zip code. Having provided the location (or a city, address, airport, or intersection, as common examples) and searching for the term “florist,” a user would typically receive a list of florists located near the provided location.

Another manner for providing an address is by having the search engine host identify the location of the internet service provided (ISP) through which the user is accessing the internet or prior Internet history. An improvement on estimating a user's location is taught by U.S. Patent Publication No. 20040010566, to Monteverde. The '566 publication teaches tracking the Internet sites that are visited by a user, identifying the location of the businesses or other entities for those Internet sites, and using this to determine a location of the user.

Global positioning system (GPS) based systems that provide location-based search results are also known. These systems utilize the GPS to determine a physical location of user so that a user need not input their location via the internet or the like. A user may submit a query to the system utilizing GPS technology such as “dry cleaners” or “gasoline,” and the device can provide directions to one or more such services or business, based on location of the user and the proximity to the services. However, the systems have no ability to predict that a person may want to go to a gasoline or fuel station without that person providing such a query.

U.S. Patent Application Publication No. 2006/0156209, to Matsuura, et al, provides further examples. In one from, the system of the '209 application attempts to recognize that whenever a person arrives at a particular location, they are likely to want to use their hand-held device to check electronic mail, this likelihood being determined by recognizing the historical tendency of the person to use electronic mail whenever the person reaches that specific location. In another form, the '209 application describes a system for utilizing statistical analysis with a hand-held device. Specifically, the system of the '209 application has pre-set parameters that are met in order for a location of a user to be recorded. As a user moves from location to location, the system records each location that meets the pre-set parameters (such as remaining at the location for a predetermined period of time sufficient to indicate that the user was not simply passing through the location). Certain data, such as date, time, etc, are recorded and associated with the location entries. The system then analyzes the historical movements of the user to predict future movements: that is, the system calculates the highest probability destinations, and presents a subset of past movements based on the most likely. Obviously, if one's history indicates an 82% likelihood of going to one of three restaurants, as described as one of the examples of the '209 application, one would not normally need directions to such restaurants. However, the '209 application attempts to provide only current information, of sorts, about the restaurants: the system of the '209 application may download and display the daily specials at each of the restaurants that the user visits a combined 82% of the time.

Again, it should be noted that nearly all results provided by the systems and methods of the '209 application are based on the user's own historical movements. The exception to this is a form in which the destination address or location of the user is known or a near certainty. For instance, the system of the '209 application may determine that the user has boarded a train that will necessarily arrive at a particular location. To do so, the system will consider the route path history for the user, and recognize that a present course of the user ultimately results in the user disembarking from the train at a particular location. In another aspect, the device of the system may recognize that it has passed a train station gate, the gate itself indicating an arrival destination. In this manner, the device is able to recognize the route that will be taken, without reliance on historical routes and without a GPS locator device. The device can then provide an estimated time of arrival at the destination station, and attempt to offer commercial information or advertisements for stores located at the destination, such as a particular store having a sale.

Accordingly, there has been a need for improved systems and methods for hand-held devices to provide and support location-based predictive services based on the user's desired or actual needs.

### SUMMARY

In accordance with an aspect, a method for providing predictive offerings to a user of a mobile device, such as, for example, a cellular telephone, is disclosed, the steps comprising supplying a present mobile device location, supplying a nature of the present mobile device location, accessing a database system of records, wherein the records include stored locations correlated with stored natures, and wherein the database system includes at least one database that includes information about offered goods and/or services, comparing the present mobile device location and nature thereof with the records, determining a predicted relevant set of offerings based on the comparing, wherein the set of offerings includes records, the stored location and correlated stored nature of each record being different than the present mobile device location and nature thereof, and presenting the relevant set of offerings on the mobile device.

In some forms, the step of supplying the present mobile device location includes the mobile device at least receiving information from at least one positioning transmitter. In some forms, the step of supplying a nature of the present mobile device location includes accessing the database system.

In some forms, the step of determining the set of offerings includes accessing records having locations and correlated natures that the device has not visited. The step of determining a set of offerings may also include accessing records having locations and correlated natures that the device has visited.

In some forms, the step of determining a set of offerings includes comparing relational associations of the records with the supplied mobile device location and supplied nature of the mobile device location. The method may include a step of providing advertisements related to the offerings.

The method may include the step of supplying present mobile device chronological information, and the step of comparing includes comparing the present chronological mobile device chronological information to stored chronological information associated with the records.

In some forms, the method may include the step of storing default natures correlated with the stored locations.

In some forms, the step of presenting the offerings includes present a map of the offerings.

In another aspect, a system for providing predictive offerings to a mobile device user is disclosed, the offerings including records having stored locations and natures associated therewith, the system comprising a mobile device providing present location information for the mobile device, a nature associated with the present mobile device location, a database system including at least a first database storing records having stored locations and correlated natures thereof, and a predictive service for comparing a present mobile device location and the nature of the present mobile device location with records, and for providing predictive offerings based on the comparison, wherein the mobile device includes a display for presenting the predictive offerings.

In some forms, the mobile device communicates with at least one positioning transmitter to determine the present mobile device location, and the database system further stores predicted natures for the mobile device location.

In some forms, the predictive offerings includes records having stored locations to which the device has not visited. The predictive offerings includes records may have stored locations to which the device has visited.

The system preferably does not require an input query by a user to display the predictive offerings.

In some forms, the system supplies present chronological information associated with the present mobile device location and associated nature, and the predictive service compares the present chronological information with stored chronological information correlated to the stored locations and correlated natures.

In some forms, the predictive service stores relational information for the records, and the predictive service compares the present mobile device location and associated nature with the stored relational information to provide the predictive offerings.

In some forms, the mobile device includes a communications capability for receiving present location information from at least one positioning transmitter, the mobile device includes a locator system for processing the present location information to determining the present mobile device location, the mobile device includes a communications capability for providing the present mobile device location to the database system, the database system selects a default nature for the present mobile device location, the database stores the present mobile device location and associated default nature as a new record, the new record comprising the present mobile device location as the stored location and the associated default nature as the correlated nature, the new record being one of the records that the device has visited, the offerings provided by the predictive service includes records having locations and correlated natures that the device has not visited and having locations and correlated natures that device has visited, the predictive service provides advertisements associated with the offerings, and the display presents the offerings and the advertisement on the mobile device.

In another aspect, a mobile device providing predictive offerings is disclosed, the mobile device comprising a communications capability for receiving present location information for the mobile device, a communications capability for transmitting the mobile device present location information to a remote system, a communications capability for receiving predictive offerings including records of stored locations and correlated natures related to and different from a present mobile device location and an associated nature thereof.

In some forms, the mobile device includes a locator system for processing the received location information and determine the present location for the mobile device.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages, should be readily understood and appreciated.

FIG. 1 depicts a graphical representation of systems of the present invention including a mobile device for providing offerings based on predictive services; and

FIG. 2 depicts a graphical flow chart of methods of the present invention.

### DETAILED DESCRIPTION

An aspect of the present invention is utilizing known information to provide a predictive service via predictive technologies. To describe a first basic step in a form of this aspect, a mobile device, such as, for example, a hand-held device or a cellular telephone, is capable to identify a present location of the mobile device and, hence, the device's user. In comparison with prior art concepts which simply utilize the present location information to identify simply positional coordinates, an aspect of the present invention also identifies information about the location, such as the nature or purpose of the location. Merely as an illustrative example, a form of the present invention utilizes the specific positional coordinates to determine that the user and device are located at a hospital doctor's office.

A subsequent step is to provide predictive services in the form of services that are likely for the user to desire, based on the nature or purpose of the location. For the above illustration, a person at the hospital doctor's office may desire to proceed to a number of locations, such as a pharmacy, a church, or a floral and card shop. The aspect of the present invention is then able to provide categorical suggested destinations, and/or specific destinations including specific addresses, maps, and directions to the destinations. In one sense, the present invention is able to assist a person determine what their needs or options may be. In another sense, the present invention is able to display a plurality of results that span across numerous possible categories, so that, in the illustration, the nearest florists may be displayed along with pharmacies and churches so that a user can make a determination as to how best to route a number of desired destinations efficiently.

As yet another example, a person may arrive at an airport, wherein the user may not know their exact whereabouts in the airport. The systems and methods of the present invention can supply the user with a number of options, including, for example, nearest locations and directions for rental cars, vehicles-for-hire, public transit, or trains. As a more specific example, a user may exit a terminal at Newark International Airport and may desire to eventually travel to Manhattan Island, New York City. The mobile device can offer transportation options, and can offer hotel suggestions, among others. For example, the mobile device may inform the user that immediately outside of the terminal is a NY/NJ Port Authority bus that goes directly into Manhattan for flat fares including tolls, either one-way or roundtrip. However, the Port Authority Bus has only a select number of drop-off and pick-up points. Moreover, the mobile device can display hotel information simultaneously with the ground transportation options, so the user can determine that a desired destination, such as a hotel on the Upper East Side of Manhattan, is not conveniently located to the drop-off points for the Port Authority Bus, and instead opt to take a vehicle-for-hire. Alternatively, the user may select from a number of suggested hotels based on the drop-off points for the Port Authority Bus.

In another aspect of the present invention, historical behavior of the mobile device user can be utilized. In the present aspect of the present invention, the systems and methods include recognizing that the user is likely to visit some restaurant, based on the user's locational history, and then presents a list of nearby restaurants (and addresses, directions, etc.), and this list likely includes restaurants the user has not visited in the past.

Accordingly, as can be readily understood, the predictive technologies of the present invention are not limited simply to a user's coordinate locations, to results of a specific user input query, or a user's historical behavior. Nonetheless, each of these facets are incorporated to provide a robust predictive technology and service to the user.

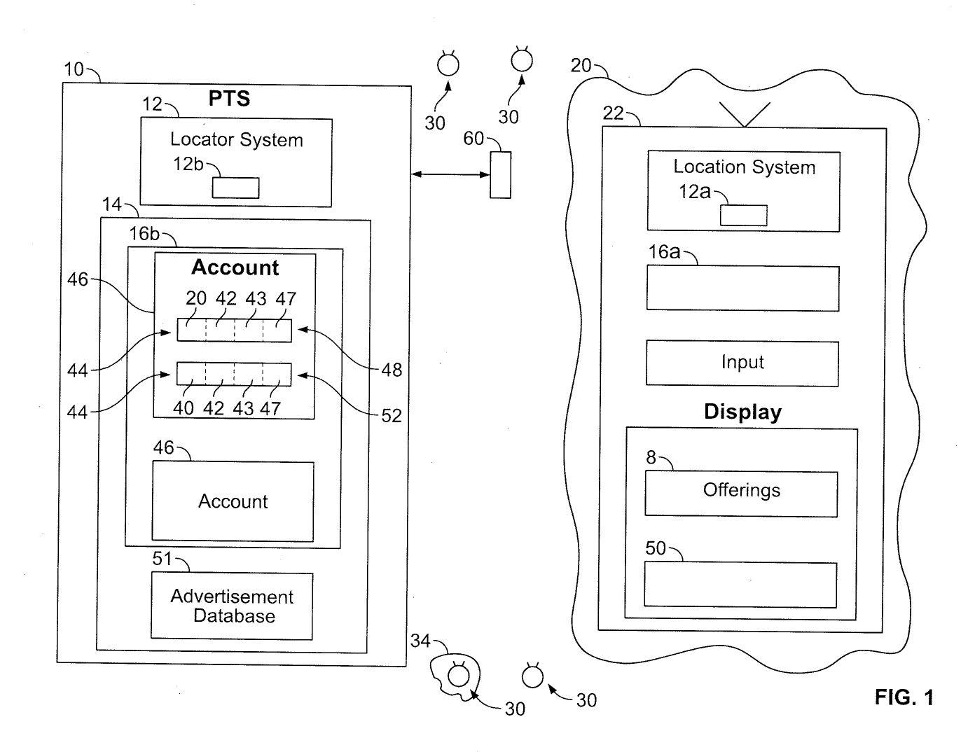

Referring now to FIG. 1, a predictive technology system, referred to herein as a PTS 10, is represented including a locator system 12 for determining a location 20 of a mobile device 22, typically a hand-held device, such as, for example, a cellular telephone or pocket PC. To determine the location of the mobile device 22, the mobile device 22 may collect coordinate information in a well-known manner, such as, for example, GPS or cellular telephony triangulation, and then determine its location 20. In yet another aspect, the mobile device 22 may obtain information related to its locational coordinates and transmit this information to the PTS 10 so that the PTS 10 can determine the mobile device location 20. Sending the information to a separate computing device, such as the PTS 10, is a basic principle of thin-client architecture devices, and use of such is within the scope of the invention as presently contemplated. However, as will be discussed below, the situs of the processing is related to privacy concerns, discussed in greater detail below.

The mobile device location 20 may be determined in a variety of manners, though the preferred method is by using a plurality of positioning transmitters 30, or transceivers. In a most preferred manner, the NAVSTAR global positioning satellite system (GPS) is utilized. A drawback to GPS, however, is that, typically, line-of-sight to at least three of the U.S. government-owned satellites (at least twenty-four in number) orbiting the earth is required in order to accurately determine the location. Additionally, a fourth satellite must be in the line-of-sight to determine altitude, which may be desirable to determine if a mobile device user is visiting, for instance, a particular floor of a high-rise or multi-story building.

A second manner for determining the device location 20 is similar to GPS, in that geometric triangulation is used by utilizing other transmitting devices 30 or transceivers. For example, as towers for cellular telephone communications are located in most urban areas, these towers provide excellent transmitting devices 30 for location-determining purposes. These towers also have the benefit of not requiring line-of-sight for receiving and transmitting information. It is noted that transmitting devices 30 may also be WI-FI hotspots, short-wave two-way radio devices, airport beacons, or any other broadcast radio wave that can carry a signal indicating its own physical location 34 from which a distance between the mobile device 22 and such physical location 34 of the transmitting device 34 can be determined for triangulation purposes. Technology also currently exists for determining a location based on directional receipt of a single beacon: therefore, minimally, the transmitters 30 comprises a single transmitter 30.

The device location 20 can also be supplied directly to the mobile device 22 by the user through an input interface provided on the mobile device 22.

The PTS 10 includes a database system 14 including one or more databases 16 for collecting and/or storing information that correlates coordinate-locations 40 with a nature 42. A particular coordinate-location 40 may be assigned one or more natures 42 such as, for instance, a park, a particular type of business (such as a florist, pharmacy, grocery store), civic building (such as courthouse, school, police station), points of interest, highway rest areas, or other non-commercial services or sites. Once a coordinate-location 40 is assigned, one or more natures 42 may then be assigned, such is referred to as a record 44. Typically, it is expected that many particular locations 40 would be assigned more than one nature 42. The database system 14 also correlates maps and directions to the records 44, and the database system 14 stores the records 44 in one or more categories and subcategories, along with relational information 43. The relational information 43 is used so that, for instance, cafes, restaurants, bars, and nightclubs may all be related in a logical manner, such as eateries, for producing coherent search results or, specifically, predictive offerings 8; in another example, relational information 43 may be directed to airports, so that hotels, car rentals, public transportation, duty-free shopping, ticket counters, and baggage claim are all recognized as being related. Such relational information 43 and processes for managing such is described in U.S. Pat. No. 7,152,059, to Monteverde, co-assigned with the present invention, the disclosure of which is incorporated in its entirety herein.

In use, it is preferred that the database system 14 collects information particular to the mobile device 22. In the event the mobile device 22 is to be used by more than one person, the collected information can be allocated to different user accounts 46 of the various users. The database system 14 stores physical locations 20 visited by the user and records these locations 20, along with other relevant data including chronological information 47 such as, for example, time of day, day of week, month of year, timing relationship to holidays, and duration of visit. These visited locations 20 are then associated with a nature 42, and the locations 20 and associated nature 42 are referred to herein as visits 48. The user may also prompt, via appropriate input, the database system 14 to record a particular visit 48 for future use. The user may assign a categorical description or nature 42 (as well as relational information) to the visit 48, or the database system 14 may supply the nature 42, so that the coordinates of the physical location 20 and the nature 42 of the visit 48 are stored as a user-specific, nature-coordinate pair. In one form, the mobile device 22 may provide a prediction of the nature 42 of the visit 48 and ask the user to verify the nature 42 so that it can be assigned to the coordinates of the visit 48, or the device 22 may display a number of possibilities (such as a list of the natures 42 previously stored in the database system 14 for a particular location 20, for example, all the businesses located in a multi-story building or a shopping mall), and the user is then prompted to select the nature 42 or natures 42 to be assigned to the visit 48.

Accordingly, the database system 14 stores records 44 that each represent, minimally, either a user specific visit 48 defined by coordinate location 20 and an associated nature 42 based on a user's historical behavior, or a universal/general record 52, referred to herein simply as a universal record 52, defined by a coordinate location 40 and a correlated nature 42 for locations 40 to which the user has not visited. To be clear, the records 44 include visits 48 and universal records 52 which are distinguished by the fact that the visits 48 are locations 20 that the user of the mobile device 22 has visited and the universal records 52 are locations 40 that the user of the mobile device 22 has not visited.

The database system 14 may store user-specific visits 48, and the database system 14 may store universal records 52. The practical utility of this is displayed by an example of, for instance, the building housing the Chicago Lyric Opera includes not only an opera house but also a number of other non-opera related businesses. The database system 14 may store the coordinates or location 40 of the Chicago Lyric Opera with a universal or default nature 42 being the Chicago Lyric Opera; this nature 42 relationally categorized as opera, a theater, an entertainment venue, etc. The database 14 also may store secondary, tertiary, etc., natures 42 for the coordinate location 40 of the Chicago Lyric Opera, and may store a nature 42 selected by a particular user, such as for a cafeteria or legal office located at the same physical coordinates or location 40. A user visiting the Chicago Lyric Opera building may select a secondary nature 42 to be associated with the visit 48 by the user.

The PTS 10 may operate in a number of modes. In a first mode, the mobile device 22 periodically checks for a change in the coordinate information to determine if the mobile device 22 has been moved. In a second mode, the mobile device 22 may be active at all times to determine physical routes of a user. While the mobile device 22 records visits 48 based on the movement of the mobile device 22 in these first two modes, a third mode requires the user to direct the mobile device 22 to store visit 48 information.

The present systems and methods described herein contemplate a number of privacy issues. A first privacy issue arises based on the situs of the processing to determine a user location 20. More specifically, if the mobile device 22 were to repeatedly broadcast its location to a remote system or database, such as part of the database system 14, the mobile device 22 may be used to track the user's movements.

There is a balance of efficiencies related to where the coordinate processing occurs. On one hand, if the processing is done on-board the mobile device 22 by a local coordinate processing module 12a, this eliminates the need for the mobile device 22 to broadcast (and possibly have intercepted) the coordinate information, and to await a reply from a remote coordinate processing module 12b of the locator system 12. On the other hand, if the processing is done off-board through the mobile device 22 transmitting information to the remote coordinate processing module 12b, this would likely reduce the power requirements for the mobile device 22, and reduce the complexity of the hardware and software needs of the mobile device 22, in the same manner as a thin-client architecture device.

With respect to privacy, utilizing a local coordinate processing module 12a avoids transmitting location device to the PTS 10 or a remote coordinate processing module 12b that could be used by a separate entity to record a user's movements. However, use of a local coordinate processing module 12a does not necessarily allow the mobile device 22 to provide the requisite predictive offerings 8, such as records 44, as desired.

More specifically, an aspect of the present invention is the utility of displaying the predictive offerings 8 on the mobile device 22, including universal records 52 and/or the user's visits 48. In order to avoid communicating the location 20 of the mobile device 22 at any particular time, either the PTS 10 must be suppressed, or the universal records 52 and visits 48 must be stored locally on the mobile device 22.

There are a number of options for storing the records 44 locally on the mobile device 22. A user may, at a predetermined time, download into a memory or local database 16a (local meaning on-board the mobile device 22), or otherwise supply (such as by flash memory, removable memory cards, USB drives, etc.) information for a particular area (such as a city). The mobile device 22, having determined a coordinate location 20 for the mobile device 22, may access the local database 16a without needing to transmit any information regarding the user's location 20.

Additionally, local storage, such as by local database 16a, allows a user to review information for predictive offerings 8 or records 44 that the user would not want recorded by a PTS 10 service provider. As discussed, a variety of hand-held devices are contemplated within the scope of the invention, including those that operate via internet service provider, cellular phone, or other service, each of which may function as or be a conduit for a PTS 10 service provider, though a mobile device 22 that does not require a specific service is also contemplated.

To maximize the robustness of the PTS 10 and mobile device 22, in terms of providing the most useful and up-to-date offerings 8 in the form of records 44 (correlated or associated coordinate-locations 40, 20 and natures 42), it is desirable to have a remote database 16b for storing of the records 44. More specifically, the universal records 52 are provided to a user as places that the mobile device 22 has not visited. To dynamically update the database system 16 and to provide the most relevant records 44, it is desirable to utilize the stored visits of other users. As with most search technologies having predictive capabilities, the PTS 10 is able to leverage the records 44 (including visits for other users) selected most frequently by others by prioritizing these records 44 for presentation to the user in the predictive offerings 8. Were the remote database 16b deprived of the information for the visits 48, the records 44 would generally not be updated, other than by a system administrator manually, and would not reflect true user popularity and patterns across a range of users.

It should also be noted that, to minimize the on-board software and hardware requirements of the mobile device 22, it is preferred to utilize the remote database 16b.

Towards at least the ends of utilizing the remote database 16b and remote coordinate processing module 12b, the mobile device 22 and PTS 10 are able to communicate with each other via a communications system 60. As noted herein, a service provider for the PTS 10 may be a cellular telephone network, for instance, providing significant coverage for well-populated areas. Nonetheless, GPS is considered more accurate, in terms of location coordinates. Therefore, it is most preferred for the mobile device 22 to communicate with the GPS satellites as the transmitting devices 30 for the purposes of collecting location 20 data, the mobile device 22 to then transmit such information to the remote processing module 12b, via the communications system 60, such as cellular telephony, for processing by the locator system 12 of the PTS 10, and the PTS 10 then to deliver offerings 8 (and advertising 50, discussed below) from the remote database 16b via the communication system 60.

Another utility of the remote database 16b is the ability of the PTS 10 to leverage advertising aspects of the predictive offerings 8 in the form of both universal records 52 and visits 48 presented to a particular user. When offerings 8 (including universal records 52 and visits 48) are displayed, advertising 50 related to these records 44 may also be displayed. If the records 44 and visits 48 are stored in a local database 16a, there is no way in which a PTS 10 service provider could charge an advertiser based on views, nor is there a way in which the advertisements 50 may be update or changed on a continual or dynamic basis.

In the present context, provision of advertising 50 related to the offerings 8 is similar to providing advertising for internet-based viewing where the advertisements 50 are correlated to a search query or search results. Specifically, when a user of a mobile device 22 receives offerings 8 in accordance with the present invention, advertisements 50 corresponding to the offerings 8 may also be displayed. More narrowly tailored advertising 50 may subsequently be displayed upon selection of a particular category of the offerings 8, a specific record 44, or a visit 48, etc. For instance, a user exiting a building at 12:01 p.m. on a Monday may be presented with either a category of nearby eateries, or a list of nearby eateries providing lunch, some of these eateries may be based on universal records 52 and some may be based on visits 48. Additionally, other categories or lists may be presented, the sum total of all categories/lists displayed constituting the offerings 8. A particular advertiser may pay for an advertisement 50 to be presented simultaneously so that either the display of the nearby eateries category or the selection of eateries category may prompt the mobile device 22 to display an advertisement 50. It should be noted that it is also contemplated that the mobile device 22 may provide audible signals, and the mobile device 22 may play an audio advertisement 50 such as a recognizable television/radio melody of a particular eatery. In any event, in an embodiment, at least a portion of the offerings 8 is based on universal records 52, i.e., places that are not based on historical visits 48 of the user.

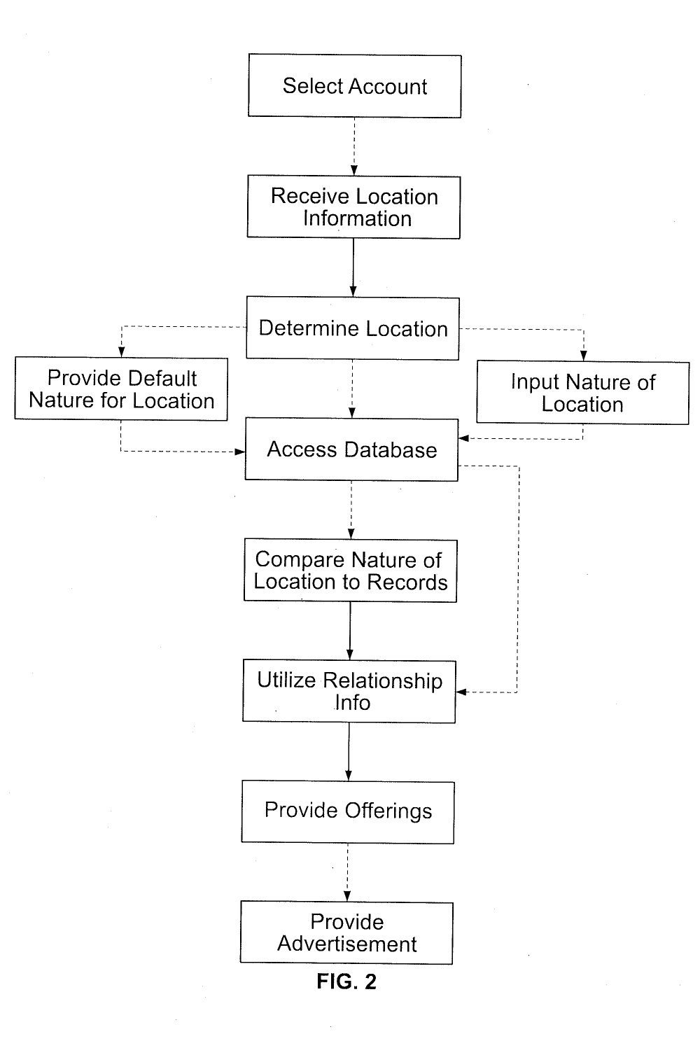

The method of use and steps of operation for the PTS 10 and mobile device 22 is illustrated in FIG. 2. A user is provided with the mobile device 22 that is able to receive information from and, in some forms, communicate with, positioning transmitters 30. The locator system 12 is utilized to determine a location 20 of the mobile device 22 at any particular time. The locator system 12 may include either the local coordinate processing module 12a, or the remote coordinate processing module 12b, for determining the location 20 of the mobile device 22 based on the information from the positioning transmitters 30. As stated, it is preferred that the mobile device 22 transmit information from the positioning transmitters 30 (preferably GPS satellites) to the remote coordinate processing module 12b, via the communications system 60, to determine the location 20 of the mobile device 22.

Principally based on the location 20 of the user, the mobile device 22 displays offerings 8 to the user, though the offerings 8 may also be selected based on other related criteria such as time of day, day of week, etc., as discussed above. The mobile device 22 may also present or play advertisements 50, stored in an advertisement database 51 of the database system 14 and related to the offerings 8. The offerings 8 may include the universal records 52 that are not based on the historical behavior of the user, and may include the visits 48 that are based on the user's historical behavior, as well as maps, directions, etc.

The offerings 8 and advertisements 50 are selected from the database system 16, either a local database 16a or, preferably, a remote database 16b. In the preferred form, the PTS 10 supplies the offerings 8 and advertisements 50 from the remote database 16, and delivers these to the mobile device 22 via the communications system 60, such as, for example, cellular telephony. In a form where the positioning transmitters 30 are part of a cellular telephone network, the communications 60 and positioning transmitters 30 may be one in the same. The offerings 8 may be displayed in a number of formats, including lists or maps with pointers, and the mobile device 22 preferably enables a selection of the display or presentation format.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A method for providing predictive offerings to a user of a mobile device, the steps comprising:
providing a mobile device location;
providing a nature of the present mobile device location;
accessing a database system having a plurality of records, wherein the records respectively include stored locations correlated with stored natures;
comparing the mobile device location and nature thereof with the records, thereby defining a location nature;
determining a predicted relevant set of offerings based on the location nature, wherein the offerings include records, the stored location and correlated stored nature of each record being different than the present mobile device location and nature thereof;
providing the relevant set of offerings to the mobile device; and
displaying the relevant set of offerings on the mobile device.

2. The method of claim 1 wherein the step of providing the mobile device location includes the mobile device receiving information from at least one positioning transmitter.

3. The method of claim 1 wherein the step of providing a nature of the mobile device location includes accessing the database system.

4. The method of claim 1 wherein the step of determining the set of offerings includes accessing records having locations and correlated natures that the device has not visited.

5. The method of claim 4 wherein the step of determining a set of offerings includes accessing records having locations and correlated natures that the device has visited.

6. The method of claim 1 wherein the step of determining a set of offerings includes comparing relational associations of the records with the supplied mobile device location and supplied nature of the mobile device location.

7. The method of claim 1 further including the step of providing advertisements related to the offerings.

8. The method of claim 1 further including the step of providing present mobile device chronological information, and the step of comparing includes comparing the present chronological mobile device chronological information to stored chronological information associated with the records.

9. The method of claim 1 including the step of storing default natures correlated with the stored locations.

10. The method of claim 1 wherein the step of presenting the offerings includes present a map of the offerings.

11. A system for providing predictive offerings to a mobile device user, the offerings including records having stored locations and natures associated therewith, the system comprising:
a mobile device adapted to provide a location information for the mobile device;
a nature associated with the present mobile device location;
a database system including at least a first database storing records having stored locations and correlated natures thereof; and
a predictive service for comparing the location and the nature of the present mobile device location with records, and for providing predictive offerings based on the comparison,
wherein the mobile device includes a display for presenting the predictive offerings.

12. The system of claim 11 wherein the mobile device communicates with at least one positioning transmitter to determine the present mobile device location, and the database system further stores predicted natures for the mobile device location.

13. The system of claim 11 wherein the predictive offerings includes records having stored locations to which the device has not visited.

14. The system of claim 13 wherein the predictive offerings includes records having stored locations to which the device has visited.

15. The system of claim 11 wherein the system does not require an input query to display the predictive offerings.

16. The system of claim 11 wherein the system supplies present chronological information associated with the present mobile device location and associated nature, and the predictive service compares the present chronological information with stored chronological information correlated to the stored locations and correlated natures.

17. The system of claim 11 wherein the predictive service stores relational information for the records, and the predictive service compares the present mobile device location and associated nature with the stored relational information to provide the predictive offerings.

18. The system of claim 11 wherein the mobile device includes a communications capability for receiving present location information from at least one positioning transmitter, the mobile device includes a locator system for processing the present location information to determining the present mobile device location, the mobile device includes a communications capability for providing the present mobile device location to the database system, the database system selects a default nature for the present mobile device location, the database stores the present mobile device location and associated default nature as a new record, the new record comprising the present mobile device location as the stored location and the associated default nature as the correlated nature, the new record being one of the records that the device has visited, the offerings provided by the predictive service includes records having locations and correlated natures that the device has not visited and having locations and correlated natures that device has visited, the predictive service provides advertisements associated with the offerings, and the display presents the offerings and the advertisement on the mobile device.

19. A mobile device providing predictive offerings, the mobile device comprising:
a communications capability for receiving present location information for the mobile device;
a communications capability for wirelessly transmitting the mobile device present location information to a remote system;
a communications capability for receiving predictive offerings including records of stored locations and correlated natures related to and different from a present mobile device location and an associated nature thereof.

20. The mobile device of claim 21 further including a locator system for processing the received location information and determine the present location for the mobile device.

21. (canceled)

22. (canceled)

23. (canceled)

24. (canceled)

25. (canceled)

26. (canceled)
